(19) United States
(12) Patent Application Publication
(10) Pub. No.: US 2015/0105974 A1
(43) Pub. Date: Apr. 16, 2015

(54) Snow Plow Blade Detection and Compensation System

(71) Applicant: Ford Global Technologies, LLC, Dearborn, MI (US)

(72) Inventors: Robert Bruce Kleve, Dearborn, MI (US); John Robert VanWiemeersch, Novi, MI (US); Anthony Pupin, Farmington Hills, MI (US); Todd Ansbacker, Westland, MI (US); John Lee, Farmington Hills, MI (US); Louis C. Gmoser, Allen Park, MI (US); Benny Vann, Farmington Hills, MI (US)

(73) Assignee: FORD GLOBAL TECHNOLOGIES, LLC, Dearborn, MI (US)

(21) Appl. No.: 14/055,410

(22) Filed: Oct. 16, 2013

(51) Int. Cl. B60W 10/00; B60W 10/20; B60W 10/30; B60W 10/18

(52) U.S. Cl. CPC B60W 10/00; B60W 10/18; B60W 10/20; B60W 10/30
USPC 701/36

(57) ABSTRACT

A snow plow blade detection and compensation system and method operable to detect when a plow blade is attached to the vehicle and then, when the driver is in plowing mode, take appropriate compensating actions. The systems and methods may include: (1) computer vision based recognition of plow blade position, wherein object recognition from a forward looking camera and computer vision system may be installed on the vehicle to recognize that the plow blade is in the down position; (2) proximity sensing system indicating that the plow blade is down, wherein multiple sensors may be used to indicate that the plow blade position is down; (3) direct input of plowing status, wherein vehicle Interfaces indicate that a plow mode is active; (4) drive pattern recognition; and/or (5) audio recognition, wherein microphones detect sound characteristics of “scraping” sounds, inferring that the plow blade is on the ground and pushing snow.

### CROSS-REFERENCE TO RELATED APPLICATIONS

Not Applicable.

### BACKGROUND OF THE INVENTION

1. Field of the Invention

The present invention relates generally to snow plow systems for vehicles; and, more specifically to detection and compensation systems for vehicles that use snow plow systems.

2. Description of Related Art

In colder climates vehicles are commonly used to plow snow. Vehicle owners typically install aftermarket snow plowing systems that may include an electrically powered plow blade at the front of the vehicle. Other equipment may also be installed, such as lights, salt spreaders and/or dump boxes, all which may have an effect on the vehicle control system. However, these systems are not commonly integrated into the vehicle control system.

Some areas of the vehicle control system that may be affected by installation and usage of a plow blade are: (1) the plow blade presence may alter the center of gravity of the vehicle by dramatically increasing the mass over the front axle, thereby changing the vehicle dynamics characteristics (e.g., braking, cornering, accelerating, and/or the like); and (2) airflow, i.e., the plow blade, when raised, may obstruct the designed airflow over the radiator and transmission cooler, for example, thereby potentially changing the powertrain cooling characteristics.

Additionally, plow blade usage (e.g., during the process of plowing snow) may affect vehicle performance by: (1) increasing electrical system load because most plows are electrically operated and demand power from the vehicle; (2) increasing demand on the vehicle's brakes, steering, engine, transmission and/or charging systems; and/or (3) changing the vehicle dynamics due to plow blade resistance (e.g., against the plowed snow), which in turn may affect traction control and/or stability control algorithms.

### SUMMARY OF THE INVENTION

The present invention includes a snow plow blade detection and compensation system. In one example a vehicle control system selectively operates to detect plow blade presence and/or plow blade usage. If present, the system can make appropriate adjustments to the braking, steering, and/or powertrain systems of the vehicle in order to compensate for the altered performance of the vehicle.

One system and method determines when a plow blade is attached to a vehicle and then, when the driver is actually in a plowing mode, take appropriate compensating actions. Various examples systems and methods for the detection of plow blade presence and plow blade usage and corresponding compensating actions are described herein.

The systems and methods may include, without limitation: (1) a computer vision based recognition of plow blade position, wherein object recognition from a forward looking camera and computer vision system may be installed on the vehicle to recognize that the plow blade is in the down position; (2) a proximity sensing system indicating that the plow blade is down, wherein multiple sensors may be used to indicate that the plow blade position is down; (3) direct input of plowing status, wherein vehicle Interfaces indicate that a plow mode is active; (4) drive pattern recognition; and/or (5) audio recognition, wherein microphones detect sound characteristics of “scraping” sounds, inferring that the plow blade is on the ground and pushing snow.

### BRIEF DESCRIPTION OF THE DRAWINGS

FIG. 1 is a flowchart of an illustrative system of several plow blade presence detection methods, which may be used alone or in combination, according to a first embodiment of the present invention.

FIG. 2 is schematic view of a vehicle with a snow plow system attached to a front portion thereof, using a plow blade sensing system according to a second embodiment of the present invention.

FIG. 3 is schematic view of a vehicle wherein the snow plow system has been removed from a front portion thereof, using a plow blade sensing system according to a third embodiment of the present invention.

FIG. 4 is a flowchart of a system that illustrates a plow blade position method according to a fourth embodiment of the present invention.

FIG. 5 is a flowchart of an alternative system that illustrates a plow blade position method according to a fifth embodiment of the present invention.

FIG. 6 is a flowchart of a system that illustrates a drive pattern recognition method according to a sixth embodiment of the present invention.

FIG. 7 is a flowchart of a system that illustrates a plow mode detection method according to a seventh embodiment of the present invention.

FIG. 8 is a schematic diagram illustrating several possible communication and/or interoperability pathways among the main operation systems/subsystems of a vehicle that includes an embodiment of the system of the present invention incorporated according to an eighth embodiment of the present invention.

### DETAILED DESCRIPTION OF THE PREFERRED EMBODIMENTS

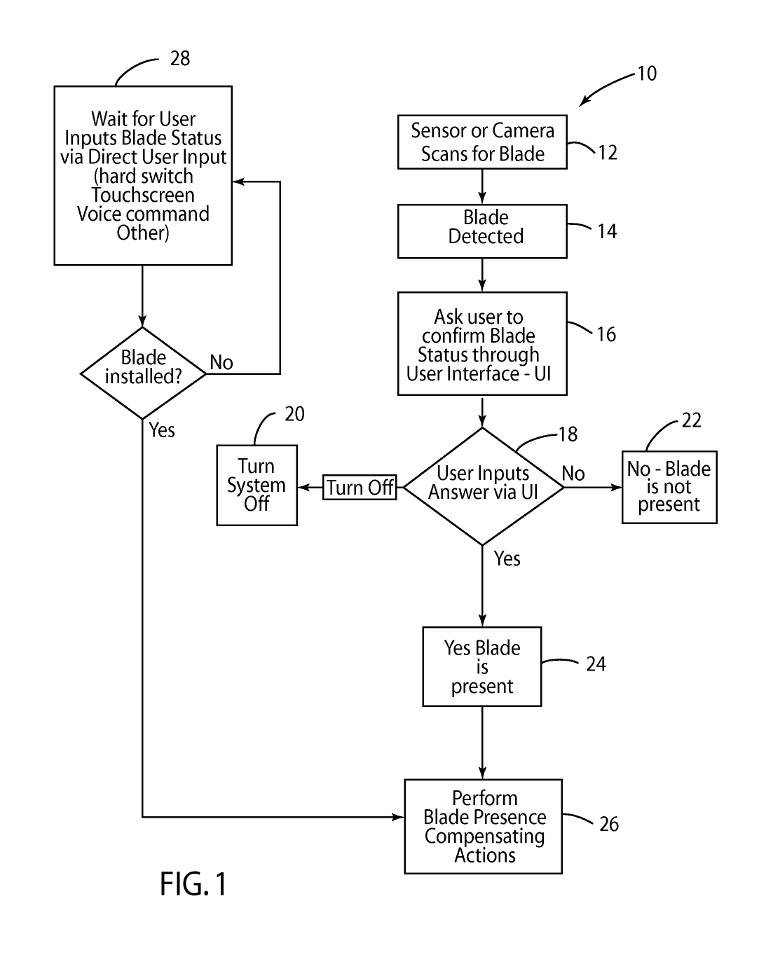

FIG. 1 shows a system flowchart, seen generally at 10, which details several examples of plow blade presence detection methods that may be used either alone or in combination.

At step 12, a sensor or camera mounted at or near a front portion of the vehicle scans for the presence of a plow blade. At step 14, a plow blade is detected. At step 16, the system 10 asks the user/driver to confirm the plow blade status (e.g., if a plow blade is indeed present on the front of the vehicle) through a user interface, described in more detail herein. At decision node 18, the user/driver is able to input an answer to the query regarding the plow blade status via the user interface. Decision node 18 can result in three different outcomes. In the first outcome, the user/driver can turn the system 10 off, as shown at step 20. In the second outcome, the user/driver can answer in the negative, i.e., a plow blade is not present, as shown at step 22. In the third outcome, the user/driver can answer in the affirmative, i.e., a plow blade is indeed present, as shown at step 24. If the user/driver answers in the affirmative, a plow blade is indeed present, appropriate vehicle compensating actions can be performed by the vehicle control system, as shown at step 26. By way of example, one or more vehicle performance parameters may be adjusted or modified if the plow blade is indeed present.

Alternatively, the user/driver can input the plow blade status via a direct user input system (a physical hard switch wired to a receiving module on the vehicle network), a soft switch (a switch found on a touchscreen), a voice command, a gesture recognition system, and/or the like, as shown at step 28. At decision node 30, the user/driver is able to input an answer regarding the plow blade status via the direct user input system. Decision node 30 can result in two different outcomes. In the first outcome, the user/driver can answer in the negative, i.e., a plow blade is not present, in which no vehicle compensating actions need to be performed by the vehicle control system. In the second outcome, the user/driver can answer in the affirmative, i.e., a plow blade is indeed present, appropriate vehicle compensating actions can be performed by the vehicle system, as shown at step 26.

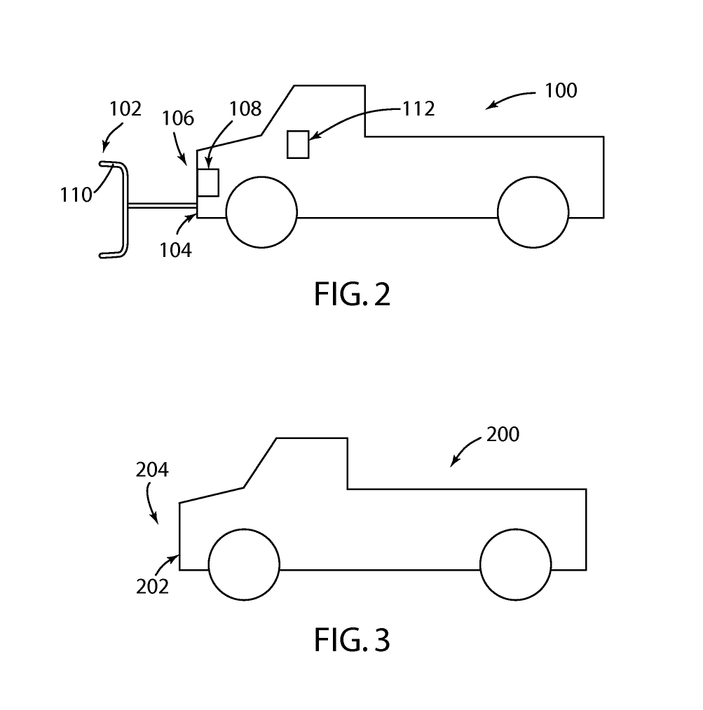

Referring to FIG. 2, there is shown a schematic view of a vehicle 100 with a snow plow system 102 attached to a front portion 104 thereof, wherein a plow blade sensing system 106 is provided. In this view, the sensing system 106 is a proximity sensor system 108 mounted at the vehicle's front portion 104.

When the proximity sensor system 108 detects the presence of a suspected plow blade 110, the vehicle's user interface system 112 requests confirmation from the user/driver that indeed a plow blade 110 is indeed installed on the vehicle 100. The user/driver may indicate that no plow blade is attached. If the request for confirmation is ignored a message may be repeated by the user interface system 112 until the user interface system 112 is turned off or the user/driver indicates a plow blade status. The user/driver may also indicate yes, i.e., that the plow blade 110 is attached, which may illuminate or activate other indications to the user/driver, telltales or messages indicating so. These indications may repeat at every key cycle until the plow blade sensing system 106 detects that the plow blade 100 has been removed. In the alternative, the user/driver can simply turn the plow blade sensing system 106 off.

Referring to FIG. 3, there is shown a schematic view of a vehicle 200 having a plow blade sensing system 204 wherein a snow plow system (not shown) has been removed from the front portion 202. For example, typically at the end of winter the plow blade is removed from the front portion 202 of the vehicle 200. The plow blade sensing system 204 will detect that the plow blade is no longer present at startup. The plow blade sensing system 204 will

Another suitable system is an object recognition system. For example, a forward looking camera and computer vision system installed on the vehicle. Similar to the above-described proximity sensor based system, when the plow blade sensing system recognizes an installation or removal of a plow blade; it requests user/driver confirmation of the change.

Any number of different sensing systems may be used in the practice of the present invention in addition to proximity sensors, camera systems, computer vision systems, and/or the like. That is, any sensing system that is operable to view an object, e.g., a plow blade, directly in front of the vehicle, and communicate that status to the vehicle's control system is suitable.

In addition to detecting the presence or absence of the plow blade the present invention provides a system and method for detecting usage of the plow blade. For example, detecting if the vehicle is in a plowing mode, the plow blade is in a position used to plow snow, and to take appropriate compensating actions. These systems and methods may be used alone or in combination with each other to reliably detect plow blade usage.

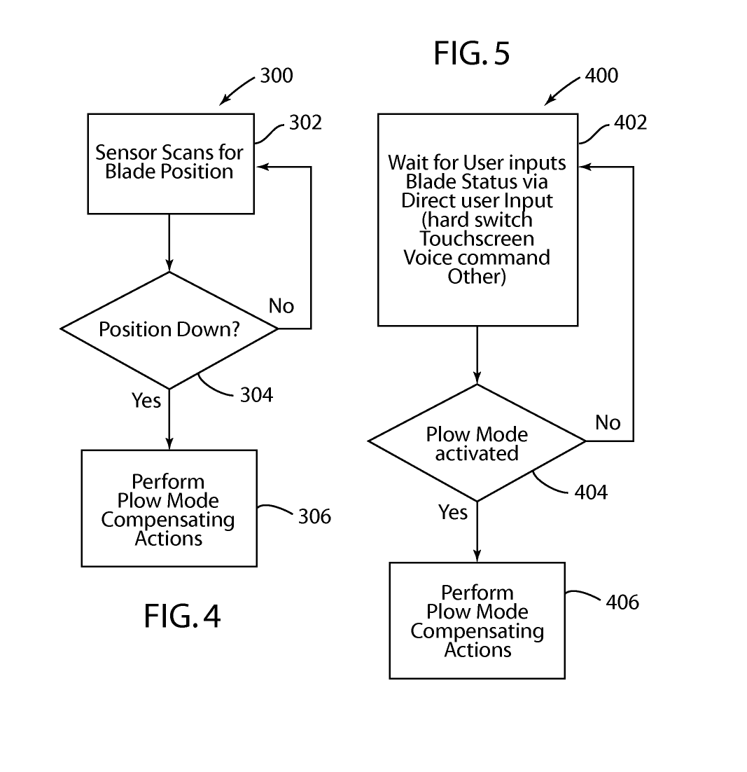

Referring to FIG. 4, there is shown a flowchart of a system 300 that details a plow blade position method. At step 302, a sensor or camera mounted at or near a front portion of the vehicle scans for the position of the plow blade. At decision node 304, the user/driver is able to input an answer to the query regarding whether the plow blade position is in the “down” or deployed position. Decision node 304 can result in two different outcomes. In the first outcome, the user/driver can answer in the negative, i.e., the plow blade is not in the “down” or deployed position. In the second outcome, the user/driver can answer in the affirmative, i.e., the plow blade is indeed in the “down” or deployed position present. If the user/driver answers in the affirmative, the plow blade is indeed in the “down” or deployed position, appropriate vehicle compensating actions can be performed by the vehicle control system, as shown at step 306.

Any number of different sensing systems may be used to determine plow blade position in addition to proximity sensors, camera systems, computer vision systems, and/or the like. That is, any sensing system that is operable to view an object, e.g., a plow blade, directly in front of the vehicle, determine its position, and communicate that status to the vehicle's control system is suitable. Multiple sensors and/or cameras, variously positioned, can also be used to determine if the plow blade is in the “down” or deployed position.

Referring to FIG. 5, there is shown a flowchart of an illustrative system 400 that details a plow blade position method. At step 402, the user/drive can input the plow blade position via a direct user input system (a physical hard switch wired to a receiving module on the vehicle network), a soft switch (a switch found on a touchscreen), a voice command, a gesture recognition system, and/or the like. At decision node 404, the user/driver is able to input an answer to the query regarding whether the plow blade position is in the “down” or deployed position, that is, is the vehicle in “plow mode” or not. Decision node 404 can result in two different outcomes. In the first outcome, the user/driver can answer in the negative, i.e., the plow blade is not in the “down” or deployed position. In the second outcome, the user/driver can answer in the affirmative, i.e., the plow blade is indeed in the “down” or deployed position present. If the user/driver answers in the affirmative, the plow blade is indeed in the “down” or deployed position, appropriate vehicle compensating actions can be performed by the vehicle control system, as shown at step 406.

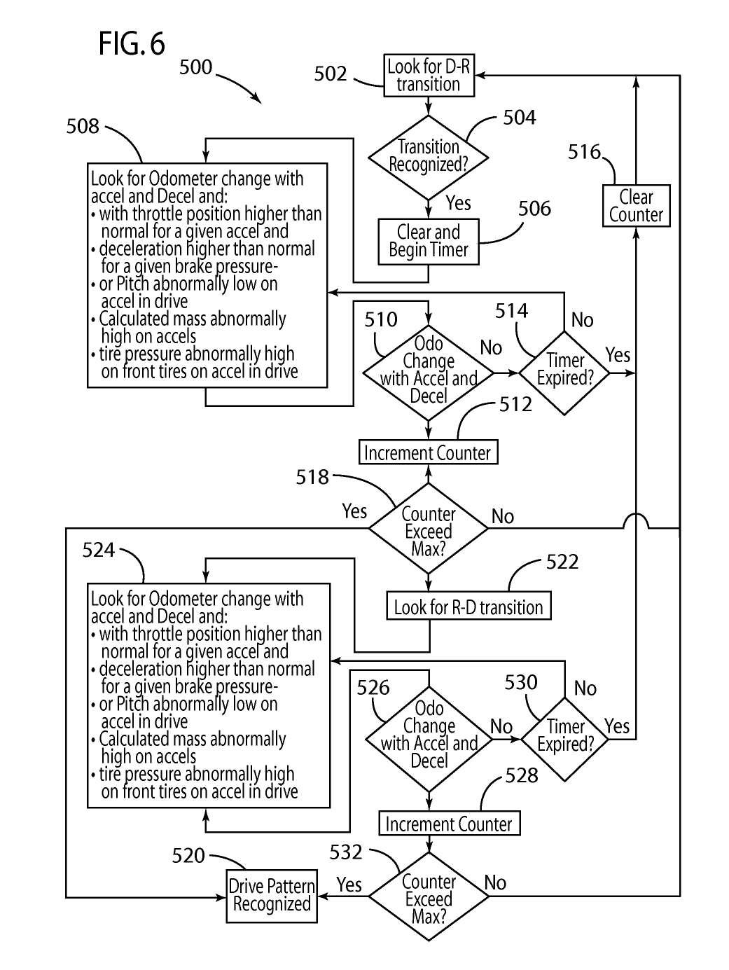

Referring to FIG. 6, there is shown a flowchart of an illustrative system 500 that details a drive pattern recognition system. At step 502, the system 500 looks for drive to reverse gear transitions. At decision node 504, the system 500 asks if a transition is recognized. If so, a timer is cleared and a new timing period commences, as shown at step 506.

Referring to Step 508, some of the indicators that the system 500 looks for to determine whether a transition has occurred are, without limitation: (1) drive to reverse with an acceleration and deceleration in between and distance traveled—i.e., the number of cycles seen within X amount of time (see decision node 510); (2) GPS movement to determine distance instead of wheel spin (a vehicle may be rocking back and forth to become unstuck in deep snow during a plowing process); (3) throttle position versus acceleration indicating abnormal load (plowing heavy snow); (4) deceleration verses brake pressure, indicating vehicle stops abnormally quickly (reflecting additional resistance of snow and ground on plow blade); (5) GPS “bread crumbing” to indicate a zigzag pattern or repeated parallel or spiraling path; (6) inclination sensors indicate abnormal pitch, e.g., lower front, or higher rear of vehicle than normal (maybe compared only during braking); (7) mass approximation of vehicle abnormally high on accelerations; and/or (8) tire pressure on front wheels abnormally high on accelerations

If these conditions are seen within a certain time period (per the timer in step 506) it can be inferred that the vehicle is likely being used to plow snow and the control system can begin an increment counter, see step 512, to confirm recognition of a drive pattern consistent with a snow plowing operation. Similarly, if the vehicle was in plow mode and none of the conditions are seen for a certain time period, it can be inferred that the vehicle is not in fact being driven in a recognized plowing drive pattern and the vehicle can rest the counter and return to looking for a pattern, see decision node 514. If the timer expired, the counter can be cleared, as shown as step 516.

If the counter exceeds a maximum threshold, see decision node 518, the system 500 achieves a drive pattern recognition, shown at step 520, or the system 500 may look for reverse to drive gear transitions, shown at step 522. If the counter does not exceed a maximum threshold, see decision node 518, the system 500 again looks for drive to reverse gear transitions, shown at step 502.

Referring to Step 524, as with step 508, some of the indicators that the system 500 looks for to determine whether a transition has occurred are, without limitation: (1) reverse to drive with an acceleration and deceleration in between and distance traveled—i.e., the number of cycles seen within X amount of time (see decision node 526); (2) GPS movement to determine distance instead of wheel spin (a vehicle may be rocking back and forth to become unstuck in deep snow during a plowing process); (3) throttle position versus acceleration indicating abnormal load (plowing heavy snow); (4) deceleration verses brake pressure indicating vehicle stops abnormally quickly (reflecting additional resistance of snow and ground on plow blade); (5) GPS “bread crumbing” to indicate a zigzag pattern or repeated parallel or spiraling path; (6) inclination sensors indicate abnormal pitch, lower front or higher rear of vehicle than normal (maybe compared only during braking); (7) mass approximation of vehicle abnormally high on accelerations; and/or (8) tire pressure on front wheels abnormally high on accelerations.

Again, if these conditions are seen within a certain time period it can be inferred that the vehicle is likely being used to plow snow and the control system can begin an increment counter, see step 528, to confirm recognition of a drive pattern consistent with a snow plowing operation. Similarly, if the vehicle was in plow mode, and none of these conditions are seen for a certain time period, it can be inferred that the vehicle is not in fact being driven in a recognized plowing drive pattern and the vehicle can rest the counter and return to looking for a pattern, see decision node 530, with counter cleared at step 516.

If the counter exceeds a maximum threshold, see decision node 532, the system 500 achieves a drive pattern recognition, at step 520. If the counter does not exceed a maximum threshold, see decision node 532, the system 500 again looks for drive to reverse gear transitions, shown at step 502.

Another system and method that may be used to detect whether the plow blade position is in the “down” or deployed position, that is, whether the vehicle is in “plow mode” or not, is through audio recognition. By way of example, SYNC™ or other microphones detecting sound characteristics of “scraping” sounds are used to infer that the plow blade is on the ground and pushing snow. Especially if these sounds are very prominent and provide a distinctive ‘scraping” sound or if they are repeated often or in a pattern, that indicates a plowing mode.

Additional condition filters can be incorporated into the detection systems of the present invention, such as, but not limited to: (1) GPS position indicates return to a place where snow plowing or only snow plowing modes have been seen in this vehicle's memory; (2) time of day; (3) temperature conditions are conceivable that snow may be present (no snow plow mode if above a certain threshold temperature); (4) GPS location & altitude indicates it is conceivable that snow could be present (no snow plow mode at sea level in tropical locations); (5) return to scene, once a snow plow mode has been activated successfully in a given location, the system leaves a GPS bookmark, whereupon returning to that point, the system can recognize this may be a location for snow plowing and prompt a confirmation.

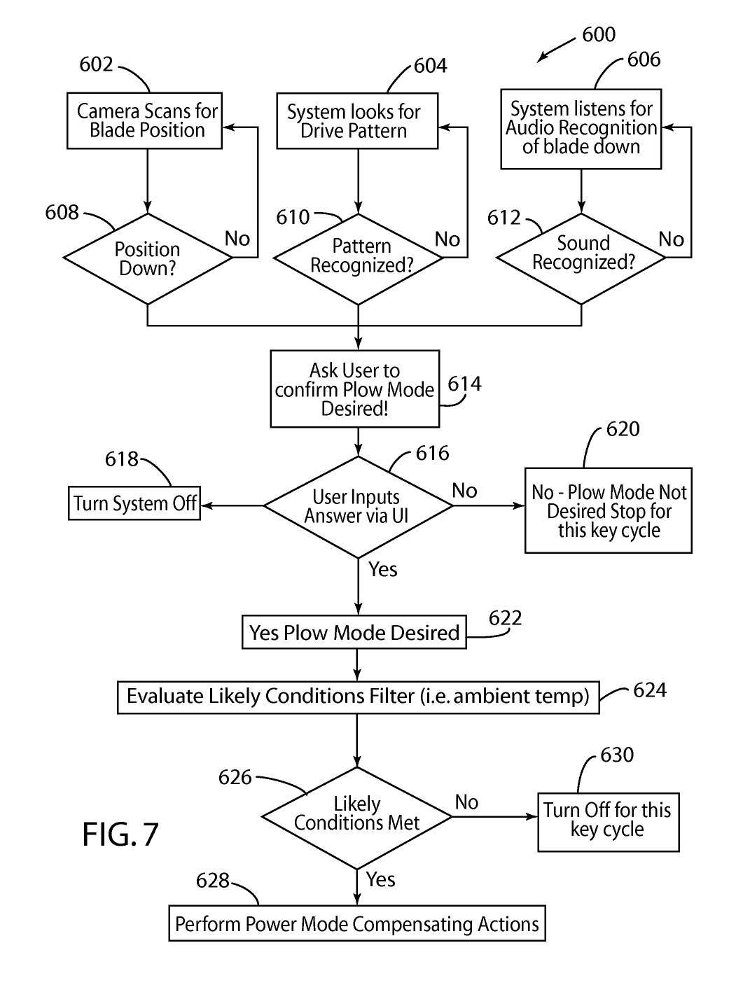

Referring to FIG. 7, there is shown a flowchart of an illustrative system 600 that details a snow plow mode detection system. At step 602, a sensor or camera mounted at or near a front portion of the vehicle scans for the position of the plow blade, at step 604 the system 600 looks for a drive pattern recognition, and at step 606 the system 600 listens for audio recognition of the plow blade being down (for example, the presence of “scraping” sounds). At decision node 608, the sensor queries whether the plow blade is in the “down” or deployed position (if no, the sensor or camera continues scanning), at decision node 610, the system 600 looks for recognition of the drive pattern (if no, the system 600 continues looking), and at decision node 612, the system 600 determines whether audio recognition indicates the plow blade is down (the presence of “scraping” sounds). If the answer is yes, the system 600 asks the user/driver to confirm that the plow mode is desired, that is the plow blade is in the “down” or deployed position, as shown in step 614. At decision node 616, the user/driver inputs the appropriate response via a user interface. Decision node 616 can result in three different outcomes. In the first outcome, the user/driver can turn the system 600 off, as shown at step 618. In the second outcome, the user/driver can answer in the negative, the plow mode is not desired and the plow blade should not be in the “down” or deployed position, as shown at step 620. In the third outcome, the user/driver can answer in the affirmative, the plow mode is desired and the plow blade should be in the “down” or deployed position, as shown at step 622. The system can then evaluate the additional filter conditions described above, as shown at step 624. If the filter conditions are indicative of a likely snow plowing environment, as shown at decision node 626, the vehicle control system performs appropriate compensating action, as shown at step 628. If the filter conditions are not met, the system 600 is turned off for this particular key cycle, as shown at step 630.

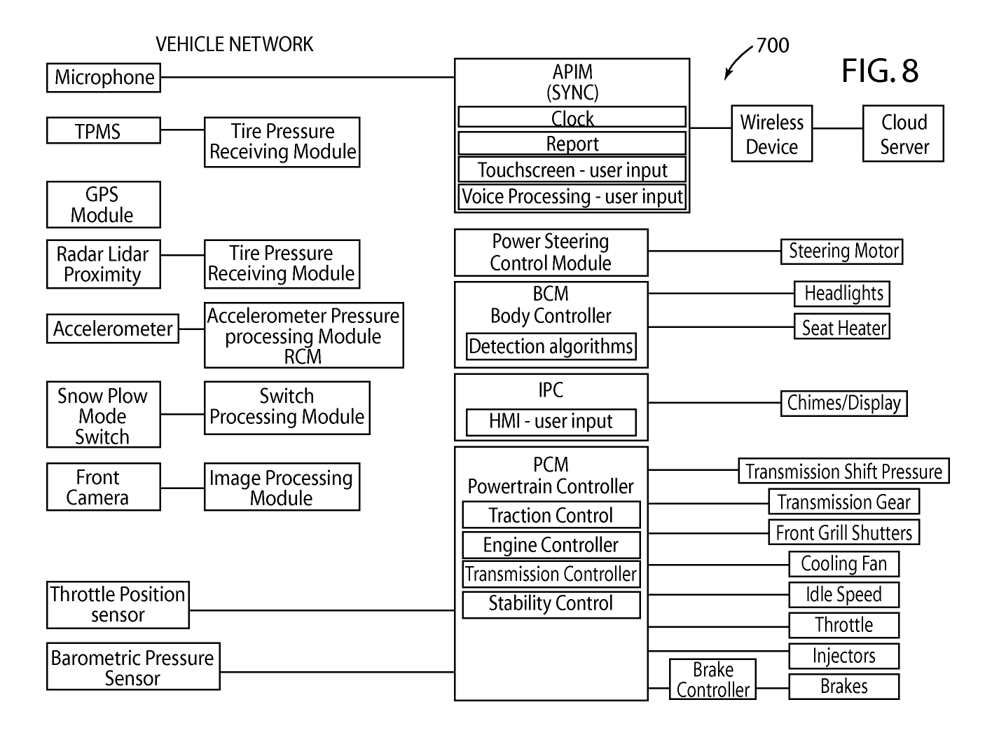

Referring to FIG. 8, and by way of example, a schematic diagram is shown illustrating several possible communication and/or interoperability pathways among the main operation systems/subsystems of a vehicle that includes the system of the present invention. It should be appreciated that the communication and/or interoperability pathways shown in FIG. 8 are for exemplary purposes only, and that they may be modified to include alternative and/or additional communication and/or interoperability pathways without departing from the scope of the invention.

Upon satisfactory detection of plow blade presence, the vehicle control system 700 may take appropriate blade-presence compensating actions, including adjusting or modifying one or more vehicle performance parameters, for example: (1) raising engine idle speed to improve cooling; (2) increasing duty cycle of cooling fan (if controllable); (3) disabling or reducing usage of front grill shutters (to improve cooling); (4) modifying traction control and/or stability control algorithms to compensate for the change in vehicle dynamics from the plow blade weight; (5) increasing braking boost; (6) modifying power-steering gain algorithms to compensate for added mass; (7) modifying any calculations that use coefficient of drag or airflow (temperature or cooling models); (8) disabling Hi-beams or Auto High beam features (to prevent reflective blinding of the user/driver; (9) disabling adaptive cruise or park assist features which may utilize the proximity sensing or camera systems. Additionally, upon satisfactory detection of plow blade usage, or “plow mode”, the vehicle control system 700 may take appropriate plow-mode compensating actions including any or all of the above mentioned actions (1)-(9) and additionally any or all of the following actions; (10) allowing customer configurable preferences in this mode, for example: (a) disabling reverse park assist warning (annoying for repeated reverse events) and/or (b) allowing choice to auto disable traction control if the driver prefers this while snow plowing; (11) flattening pedal demand curve for more controllable low speed/high torque maneuvering; (12) modifying transmission shift points and pressure (firmness) for optimum snow plowing; (13) providing 2^{nd} gear start for more controllable launch; (14) engaging engine braking clutches in the automatic transmission which increases engine braking and reduces brake wear; (15) shedding unnecessary electrical loads (like heated seats) to preserve battery life; and/or (16) logging of location, “bread-crumbing” for returning and for driving pattern recognition.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A detection and compensation system for vehicles using a snow plow system including a plow blade, comprising:
a detection system selectively operable to detect the presence or absence of the plow blade, and if the plow blade is present to optionally determine the position of the plow blade; and
a compensation system in communication with the detection system;
wherein the compensation system is operable to adjust a vehicle performance parameter when the detection system detects the presence of the plow blade.

2. The detection and compensation system according to claim 1, wherein the detection system is selected from the group consisting of a sensor, a camera, an audio recognition device, a user interface, a drive pattern recognition system, and combinations thereof.

3. The detection and compensation system according to claim 2, wherein the audio recognition device is selectively operable to detect a sound pattern corresponding to the plow blade plowing snow.

4. The detection and compensation system according to claim 2, wherein the user interface includes a direct user input system.

5. The detection and compensation system according to claim 4, wherein the direct user input system is selected from the group consisting of a switch system, a touchscreen, a voice command system, a gesture recognition system, and combinations thereof.

6. The detection and compensation system according to claim 2, wherein the drive pattern recognition system includes a factor selected from the group consisting of gear shifting from drive to reverse with an acceleration and deceleration in between and distance traveled, GPS movement to determine distance instead of wheel spin, throttle position versus acceleration, deceleration verses brake pressure, GPS pattern tracking, inclination sensors indicating abnormal pitch, mass approximation of vehicle abnormally high on accelerations, tire pressure on front wheels high on accelerations, and combinations thereof.

7. The detection and compensation system according to claim 1, wherein the vehicle performance parameter is selected from the group consisting of raising engine idle speed, increasing duty cycle of a cooling fan, disabling or reducing usage of a front grill shutter, modifying traction control and/or stability control algorithms, increasing braking boost, modifying power-steering gain algorithms, modifying calculations that use coefficient of drag or airflow, disabling hi-beam or auto high beam features, disabling adaptive cruise or park assist features, allowing customer configurable preferences by disabling reverse park assist warning or allowing choice to auto disable traction control, flattening pedal demand curve, modifying transmission shift points and pressure, providing 2^{nd} gear start, engaging engine braking clutches in an automatic transmission, shedding unnecessary electrical loads, logging of location, and combinations thereof.

8. A detection and compensation system for vehicles using a snow plow system including a plow blade comprising:
a detection system selectively operable to detect the presence or absence of the plow blade, and if the plow blade is present to optionally determine the position of the plow blade;
wherein the detection system is selected from the group consisting of a sensor, a camera, an audio recognition device, a user interface, a drive pattern recognition system, and combinations thereof; and
a compensation system in communication with the detection system, wherein the compensation system includes a vehicle control system;
wherein the vehicle control system is selectively operable to adjust a vehicle performance parameter when the detection system detects the presence of the plow blade.

9. The detection and compensation system according to claim 8, wherein the audio recognition device is selectively operable to detect a sound pattern corresponding to the plow blade plowing snow.

10. The detection and compensation system according to claim 8, wherein the user interface includes a direct user input system.

11. The detection and compensation system according to claim 10, wherein the direct user input system is selected from the group consisting of a switch system, a touchscreen, a voice command system, a gesture recognition system, and combinations thereof.

12. The detection and compensation system according to claim 8, wherein the drive pattern recognition system includes a factor selected from the group consisting of gear shifting from drive to reverse with an acceleration and deceleration in between and distance traveled, GPS movement to determine distance instead of wheel spin, throttle position versus acceleration, deceleration verses brake pressure, GPS pattern tracking, inclination sensors indicating abnormal pitch, mass approximation of vehicle abnormally high on accelerations, tire pressure on front wheels high on accelerations, and combinations thereof.

13. The detection and compensation system according to claim 8, wherein the vehicle performance parameter is selected from the group consisting of raising engine idle speed, increasing duty cycle of a cooling fan, disabling or reducing usage of a front grill shutter, modifying traction control and/or stability control algorithms, increasing braking boost, modifying power-steering gain algorithms, modifying calculations that use coefficient of drag or airflow, disabling hi-beam or auto high beam features, disabling adaptive cruise or park assist features, allowing customer configurable preferences by disabling reverse park assist warning or allowing choice to auto disable traction control, flattening pedal demand curve, modifying transmission shift points and pressure, providing 2^{nd} gear start, engaging engine braking clutches in an automatic transmission, shedding unnecessary electrical loads, logging of location, and combinations thereof.

14. A detection and compensation system for vehicles using a snow plow system including a plow blade comprising:
a detection system selectively operable to detect the presence or absence of the plow blade, and if the plow blade is present to optionally determine the position of the plow blade;
wherein the detection system is selected from the group consisting of a sensor, a camera, an audio recognition device, a user interface, a drive pattern recognition system, and combinations thereof; and
a compensation system in communication with the detection system, wherein the compensation system includes a vehicle control system;
wherein the vehicle control system is selectively operable to adjust a vehicle performance parameter when the detection system detects the presence of the plow blade, wherein the vehicle performance parameter is selected from the group consisting of raising engine idle speed, increasing duty cycle of a cooling fan, disabling or reducing usage of a front grill shutter, modifying traction control and/or stability control algorithms, increasing braking boost, modifying power-steering gain algorithms, modifying calculations that use coefficient of drag or airflow, disabling hi-beam or auto high beam features, disabling adaptive cruise or park assist features, allowing customer configurable preferences by disabling reverse park assist warning or allowing choice to auto disable traction control, flattening pedal demand curve, modifying transmission shift points and pressure, providing 2^{nd} gear start, engaging engine braking clutches in an automatic transmission, shedding unnecessary electrical loads, logging of location, and combinations thereof.

15. The detection and compensation system according to claim 14, wherein the audio recognition device is selectively operable to detect a sound pattern corresponding to the plow blade plowing snow.

16. The detection and compensation system according to claim 14, wherein the user interface includes a direct user input system.

17. The detection and compensation system according to claim 16, wherein the direct user input system is selected from the group consisting of a switch system, a touchscreen, a voice command system, a gesture recognition system, and combinations thereof.

18. The detection and compensation system according to claim 14, wherein the drive pattern recognition system includes a factor selected from the group consisting of gear shifting from drive to reverse with an acceleration and deceleration in between and distance traveled, GPS movement to determine distance instead of wheel spin, throttle position versus acceleration, deceleration verses brake pressure, GPS pattern tracking, inclination sensors indicating abnormal pitch, mass approximation of vehicle abnormally high on accelerations, tire pressure on front wheels high on accelerations, and combinations thereof.
